(19) United States
(12) Patent Application Publication
(10) Pub. No.: US 2026/0328032 A1
(43) Pub. Date: Oct. 22, 2026

(54) REFRIGERATOR

(71) Applicant: LG Electronics Inc., Seoul (KR)

(72) Inventor: Jungil SHIN, Seoul (KR)

(21) Appl. No.: 19/538,016

(22) Filed: Feb. 12, 2026

(30) Foreign Application Priority Data
Apr. 21, 2025 (KR) 10-2025-0051836

(51) Int. Cl. E05D 11/10; F25D 23/06

(52) U.S. Cl. CPC E05D 11/1078; F25D 23/062

(57) ABSTRACT

A refrigerator includes: a cabinet defining a storage compartment that is open toward a front; a door rotatably disposed at a front of the cabinet to open and close the storage compartment; a hinge including a hinge shaft configured to rotatably support the door and a reference pin spaced apart from the hinge shaft, the hinge being fixed to the cabinet; and a closing device configured to provide a force in a direction in which the door is closed. The closing device includes: a catcher including a slit into which the reference pin is inserted and configured to be rotatable; a cam configured to rotate integrally with the catcher; and an auto closing module configured to apply a force to the cam to rotate the catcher.

### CROSS-REFERENCE TO RELATED APPLICATIONS

This application claims the benefit of Korean Patent Application No. 10-2025-0051836, filed on Apr. 21, 2025. The disclosure of the prior application is incorporated by reference in its entirety.

### BACKGROUND

### 1. Field

The present disclosure relates to a refrigerator, and more particularly, to a door of a refrigerator.

### 2. Description of the Related Art

A refrigerator is a home appliance that includes a storage compartment to keep food ingredients, beverages, and the like fresh, and maintains a low temperature by supplying cold air into the storage compartment. Such a storage compartment is typically divided into a freezing compartment and a refrigerating compartment, and each storage compartment is opened and closed by a respective door.

A door of the refrigerator is opened to allow a user to access the storage compartment and is closed again after use so as to maintain a constant internal temperature of the storage compartment. A type of the door may vary depending on the position and structure of the storage compartment. Examples include a pivoting (or rotating) door that is opened and closed by rotation, and a drawer-type door that slides back and forth. Among these, the pivoting door is the most commonly used configuration, and the door rotates about a hinge shaft in response to a user’s opening and closing operation.

In the case of a pivoting door, if a user does not close the door fully, the door may not be completely closed and remain slightly open. This may cause cold air to escape from the interior, or lead to the spoilage of stored items.

To prevent such problems, there has been a demand for an auto-closing function that induces the door to automatically close when the door is opened within a predetermined angle.

Registered Utility Model Publication No. 20-0361297 (hereinafter referred to as Prior Art Document 1) discloses a hinge for an auto closing door. The auto-closing mechanism of Prior Art Document 1 is directly coupled to the door hinge and provides a closing force to the door.

However, such a structure has room for improvement in terms of diversification of door structures, increasing design requirements, device durability, etc.

Registered Patent Publication No. 10-2428942 (hereinafter referred to as Prior Art Document 2) discloses a door opening and closing device. As for the door opening and closing device of Prior Art Document 2, a roller is provided at an end portion of a rotating member that receives an elastic force from a torsion spring, and the roller moves along a rolling surface of a hinge bracket to provide a closing force to the door.

This structure can restore the door at a certain angle without directly applying a force to the hinge shaft. However, depending on the shape of the bracket of the hinge, there may be a possibility that the force provided to the door by the auto closing device acts in a door-opening direction.

Meanwhile, an insulating material is filled in the refrigerator door to maintain the internal temperature of the storage compartment. When the configuration for closing the door is arranged in an up-down (or vertical) direction as in Prior Art Documents 1 and 2, a portion of a such a configuration may overlap with the storage compartment in a front-rear direction, and the insulating material in that portion may be absent or insufficient.

### SUMMARY

It is an object of the present disclosure to solve the above and other problems.

It is another object of the present disclosure to provide a refrigerator in which a door automatically closes when an opening angle of the door is equal to or less than a predetermined angle.

It is another object of the present disclosure to provide a refrigerator including a closing device that can be applied to doors with various structures.

It is another object of the present disclosure to provide a refrigerator in which an auto closing module interacts with a component other than a hinge shaft to close a door.

It is another object of the present disclosure to provide a refrigerator including an auto closing module without degrading thermal insulation performance.

It is another object of the present disclosure to provide a refrigerator in which a position of a catcher is fixed when a door is in an open state.

It is another object of the present disclosure to provide a refrigerator in which a position of a catcher is constant in an open state and/or a closed state of a door.

It is another object of the present disclosure to provide a refrigerator in which an elastic force of an auto-closing module is adjustable.

It is another object of the present disclosure to provide a refrigerator that automatically closes a door when an opening angle of the door is equal to or less than a predetermined angle, guides the door to close softly by reducing the impact between a cabinet and the door during closing, and improves operational feel.

It is another object of the present disclosure to provide a refrigerator in which an auto-closing module and a soft-closing module are modularized into a single device.

It is another object of the present disclosure to provide a refrigerator in which a volume occupied by a closing device including an auto closing module and a soft closing module is small.

It is another object of the present disclosure to provide a refrigerator in which a section where a damping force of a soft closing module is provided during door closing is optimally designed.

The objects of the present disclosure are not limited to the objects described above, and other objects not stated herein will be clearly understood by those skilled in the art from the following description.

In accordance with an aspect of the present disclosure, a refrigerator may include a cabinet and a door.

The cabinet may define a storage compartment. The storage compartment may be open toward a front.

The door may be disposed at a front of the cabinet. The door may be rotatably provided at the front of the cabinet. The door may open and close the storage compartment.

The refrigerator may include a hinge. The hinge may include a hinge shaft to rotatably support the door. The hinge may be fixed to the cabinet.

The hinge may include a reference pin. The reference pin may be spaced apart from the hinge shaft.

The refrigerator may include a closing device configured to provide a force to the door. The closing device may provide a force in a direction in which the door is closed.

The closing device may include a catcher that is rotatably provided and an auto closing module configured to rotate the catcher.

The catcher may include a slit into which the reference pin is inserted.

The closing device may include a cam configured to rotate integrally with the catcher.

The auto closing module may apply a force to the cam to rotate the catcher.

A rotation center of the catcher may be oriented vertically.

The auto closing module may be disposed in a direction intersecting the rotation center of the catcher. The auto closing module may be disposed horizontally.

The auto closing module may include a spring. The spring may be disposed in a direction intersecting the rotation center of the catcher. The spring may be disposed horizontally.

The auto closing module may include a holder coupled to a first end of the spring.

The auto closing module may include an actuator coupled to a second end of the spring. The actuator may be configured to slide along a longitudinal direction of the spring. The actuator may contact the cam.

The actuator may include an acting surface and a locking surface. The acting surface and the locking surface may contact the cam.

A rotation center of the cam may intersect a normal of the locking surface. The rotation center of the cam may be located between the normal of the locking surface and a normal of the acting surface.

The cam may contact the locking surface when the reference pin is located outside the slit.

The cam may contact the acting surface when the reference pin is located in the slit.

The cam may include an opposing surface. The opposing surface may contact the locking surface when the reference pin is located outside the slit.

The cam may include a roller that contacts the actuator.

The closing device may further include a housing to accommodate the auto closing module.

The auto closing module may further include a force adjusting part to adjust a position of the holder relative to the housing.

The closing device may further include a cam support located with respect to the cam in a second rotational direction of the cam. The second rotational direction may be a direction in which the cam rotates when the door is opened. The second rotational direction may be opposite to a first rotational direction in which the cam rotates when the door closes.

The cam may include a first arm protruding from a rotation center of the cam toward the auto closing module.

The cam may include a second arm protruding from the rotation center of the cam and disposed between the first arm and the cam support.

The closing device may further include a cam stopper that is located on a second rotational direction side opposite to the first rotational direction with respect to the second arm and contacts the second arm when the door closes.

The closing device may further include a soft closing module configured to apply a force to the cam in a direction opposite to the force applied by the auto closing module.

The cam may include: a first arm protruding from a rotation center of the cam toward the auto closing module; and a second arm protruding from the rotation center of the cam toward the soft closing module.

The closing device may include a case. The case may accommodate the cam, the auto closing module, and the soft closing module. The case may be mounted to the door.

The auto closing module may be disposed above or below the soft closing module.

A longitudinal center of the auto closing module and a longitudinal center of the soft closing module may be spaced apart in a front-rear direction of the door.

The longitudinal center of the auto closing module and the longitudinal center of the soft closing module may be spaced apart from the rotation center of the cam toward the front of the door.

When the reference pin is located at an outer end of the slit, the first arm may contact the auto closing module, and the second arm may be spaced apart from the soft closing module.

The soft closing module may include: a damper configured to provide a force applied to the cam; and a head that is coupled to the damper and contacts the second arm.

The head may include an inclined surface that is directed toward the rotation center of the cam and contacts the second arm when the door is in a closed state.

Details of other embodiments are included in the detailed description and the accompanying drawings.

According to at least one of the embodiments of the present disclosure, it is possible to provide a refrigerator in which a door automatically closes when an opening angle of the door is equal to or less than a predetermined angle.

According to at least one of the embodiments of the present disclosure, it is possible to provide a refrigerator including a closing device that can be applied to doors with various structures.

According to at least one of the embodiments of the present disclosure, it is possible to provide a refrigerator in which an auto closing module interacts with a component other than a hinge shaft to close a door.

According to at least one of the embodiments of the present disclosure, it is possible to provide a refrigerator including an auto closing module without degrading thermal insulation performance.

According to at least one of the embodiments of the present disclosure, it is possible to provide a refrigerator in which a position of a catcher is fixed when a door is in an open state.

According to at least one of the embodiments of the present disclosure, it is possible to provide a refrigerator in which a position of a catcher is constant in an open state and/or a closed state of a door.

According to at least one of the embodiments of the present disclosure, it is possible to provide a refrigerator in which an elastic force of an auto-closing module is adjustable.

According to at least one of the embodiments of the present disclosure, it is possible to provide that automatically closes a door when an opening angle of the door is equal to or less than a predetermined angle, guides the door to close softly by reducing the impact between a cabinet and the door during closing, and improves operational feel.

According to at least one of the embodiments of the present disclosure, it is possible to provide a refrigerator in which an auto-closing module and a soft-closing module are modularized into a single device.

According to at least one of the embodiments of the present disclosure, it is possible to provide a refrigerator in which a volume occupied by a closing device including an auto closing module and a soft closing module is small.

According to at least one of the embodiments of the present disclosure, it is possible to provide in which a section where a damping force of a soft closing module is provided during door closing is optimally designed.

### BRIEF DESCRIPTION OF THE DRAWINGS

FIG. 1 is a front view of a refrigerator according to an embodiment of the present disclosure.

FIG. 2 illustrates a perspective view of a door shown in FIG. 1 and an enlarged view of a closing device.

FIG. 3 is a bottom view of the door shown in FIG. 2.

FIG. 4 is an exploded view of the closing device shown in FIG. 2.

FIG. 5 is a sectional perspective view of a first housing shown in FIG. 4.

FIGS. 6A and 6B illustrate an enlarged view and a bottom view of a cam shown in FIG. 4.

FIGS. 7A - 7F are perspective views illustrating an assembly order of the closing device shown in FIG. 4.

FIGS. 8 and 9 are cross-sectional views of the closing device shown in FIG. 2.

FIGS. 10A and 10B and 11 are cross-sectional views of the closing device shown in FIG. 9.

FIGS. 12A - 12E are bottom views illustrating positions of a hinge and a catcher according to an opening angle of a door.

FIGS. 13A - 13E are cross-sectional views illustrating states of a catcher, a cam, and an auto closing module according to an opening angle of a door.

FIGS. 14A - 14E are cross-sectional views illustrating states of a catcher, a cam, and a soft closing module according to an opening angle of a door.

FIGS. 15A - 15C are cross-sectional views of a closing device of a refrigerator according to a second embodiment of the present disclosure.

FIGS. 16 and 17A and 17B are perspective views and plan views, respectively, of a closing device of a refrigerator according to a third embodiment of the present disclosure.

FIG. 18 is a perspective view of a closing device of a refrigerator according to a fourth embodiment of the present disclosure.

FIGS. 19 and 20 are cross-sectional views of the closing device shown in FIG. 18.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand various technical features and it should be understood that the embodiments disclosed herein are not limited by the accompanying drawings. As such, the present disclosure should be construed to extend to any alterations, equivalents, and substitutes in addition to those which are particularly set out in the accompanying drawings.

Although the terms “first”, “second”, etc. may be used herein to describe various elements, these elements should not be limited by these terms. These terms are only used to distinguish one element from another.

It will be understood that when a component is referred to as being “coupled” or “connected” to another component, it may be directly coupled or connected to another component, or intervening components may be present. In contrast, when a component is referred to as being “directly coupled” or “directly connected” to another component, there are no intervening components present.

A singular representation may include a plural representation unless the context clearly indicates otherwise.

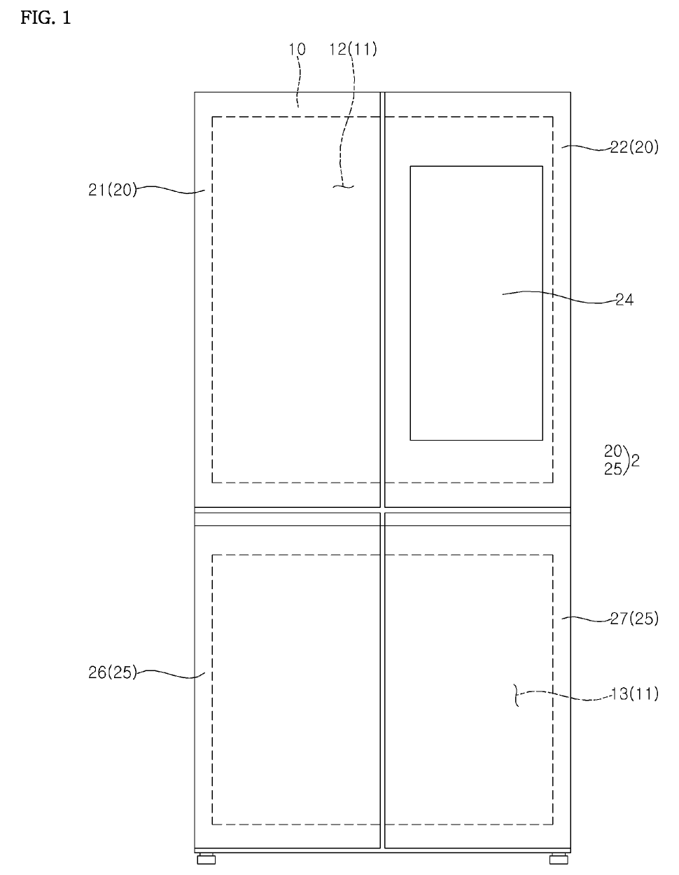

Referring to FIG. 1, a refrigerator 1 according to an embodiment of the present disclosure includes a cabinet 10 defining a storage compartment 11 and a door 2 configured to open and close the storage compartment 11.

The storage compartment 11 may be open toward the front. The storage compartment 11 may provide a space and/or a configuration for storing food or beverages therein. The storage compartment 11 may be open toward the front so as to facilitate user access and food storage.

The storage compartment 11 may be provided in plurality. For example, the storage compartment 11 may include an upper storage compartment 12 and a lower storage compartment 13 that are vertically divided. The upper storage compartment 12 may be provided as a refrigerating compartment, and the lower storage compartment 13 may be provided as a freezing compartment. However, the configurations of the refrigerating compartment and the freezing compartment are not limited thereto.

The door 2 may form a front surface of the refrigerator.

The door 2 may be provided at the front of the cabinet 10 to open and close the storage compartment 11. The door 2 may be rotatably provided at the front of the cabinet 10 to open and close the storage compartment 11.

When closed, the door 2 may block the storage compartment 11 from the outside. When opened, the door 2 may allow a user to access the storage compartment 11 to store or retrieve food.

The door 2 may include an upper door 20 to open and close the upper storage compartment 12. The door 2 may include a lower door 25 to open and close the lower storage compartment 13.

A plurality of doors 2 may be provided. The plurality of doors 2 may open and close a single storage compartment. For example, a first door 21 and a second door 22 may together open and close one upper storage compartment 12. That is, the first door 21 may open and close a portion (a left portion in FIG. 1) of the upper compartment 12, and the second door 22 may open and close another portion (a right portion in FIG. 1) of the upper storage compartment.

Alternatively, a plurality of the doors 20 may be provided, and each door may open and close a respective storage compartment. For example, the lower storage compartment 13 may be divided into left and right sections to provide two storage compartments, and the lower door 25 that opens and closes the lower storage compartment 13 may include a first lower door 26 to open and close a left lower storage compartment and a second lower door 27 to open and close a right lower storage compartment.

The plurality of storage compartments 11 and doors 2 described above may be configured differently. For example, the upper storage compartment 12 may be divided into left and right sections, or the lower storage compartment 13 may be configured as a single storage compartment without being divided into left and right sections.

Food may be stored in the storage compartment 11. Cold air may be supplied to the storage compartment 11. The door 20 may close the storage compartment 11 to block cold air from leaking to the outside.

The refrigerator 1 may include a refrigeration cycle. Through the refrigeration cycle, air may be heat-exchanged with a refrigerant to supply cold air to the storage compartment 11.

The door 20 may be opened to allow a user to access the storage compartment 11.

A shelf and/or a drawer may be provided inside the storage compartment 11. The door 2 may also be provided with a shelf to allow food to be stored.

In addition, a storage space may be formed on an inner side of the door 2, thereby increasing storage capacity.

The door 2 may further include a window 24. The window 24 may be made of a transparent or semi-transparent material, thereby allowing the inside of the storage compartment to be visually recognized from the outside.

The window 24 may allow food stored inside to be identified from the outside when lighting inside the door or the storage compartment is turned on.

The window 24 may have a display function.

The window 24 may be implemented as a smart window serving as a user interface to display internal states or to enable external control input.

A shelf or a drawer may be provided inside the storage compartment 11 to allow food to be stored.

A left-right direction of FIG. 1 may be referred to as a width direction of the refrigerator, a width direction of the cabinet 10, or a width direction of the door 2.

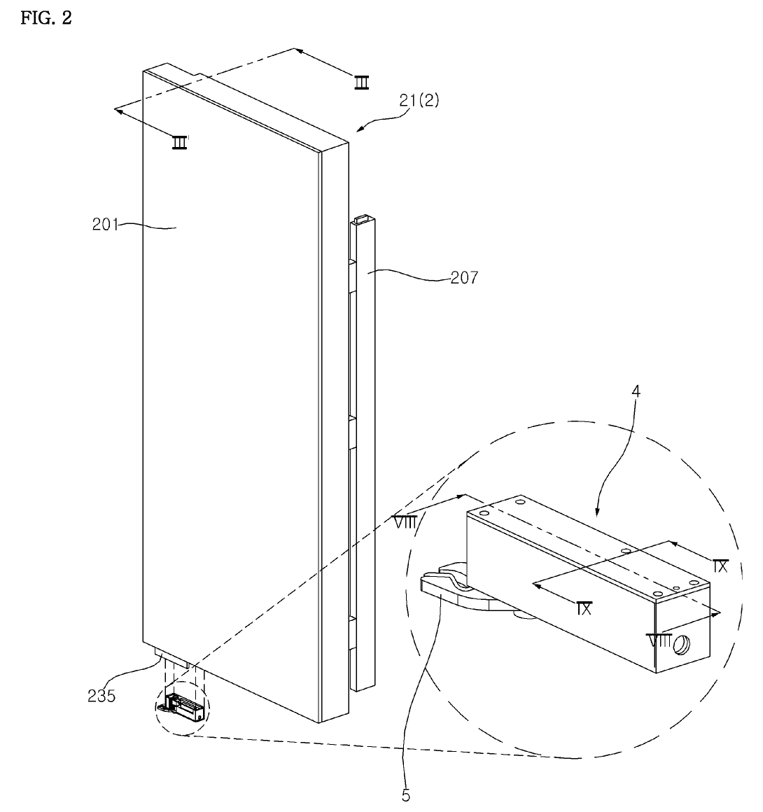

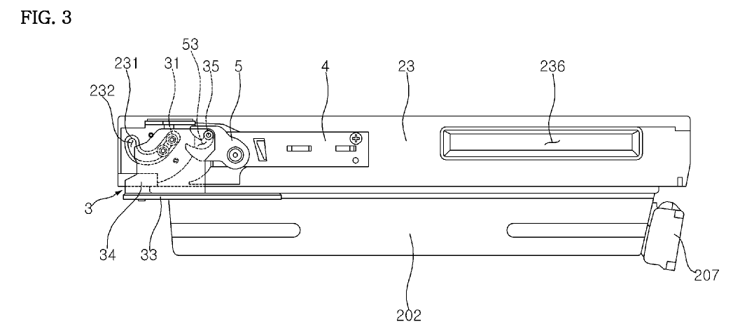

The door 2 will be described with reference to FIGS. 2 and 3. In the following description, the first door 21 is described as an example, but the features described below may also be applicable to the second door 20 or the lower door 25.

Referring to FIG. 2, the door 2 may include a door panel 201 that defines an outer appearance. The door panel 201 may form a front surface of the door 2. The front surface of the door 2 may also be referred to as the front surface of the refrigerator.

The door panel 201 may be exposed to the outside, and may form a surface visually recognized by a user. The door panel 201 may be made of various materials such as metal, plastic, or a composite material.

Hereinafter, the door panel 201 will also be referred to as the front surface 201 of the door.

A filler 207 may be provided at one side of the door 2. The filler 207 may be provided at the rear of the door 2.

The filler 207 may serve to close a gap between the first door 21 and the second door 22, and may enhance thermal insulation and exterior quality when the doors are both closed.

The filler 207 may be rotatably installed to be interlocked with opening and closing operations of the door.

According to an embodiment of the present disclosure, the refrigerator includes a closing device 4. The closing device 4 may provide a force in a direction in which the door 2 is closed. The closing device 4 may apply a force to the door 2 in a closing direction.

The closing device 4 may include a catcher 5 that is rotatably provided.

The closing device 4 may be mounted on an upper portion and/or a lower portion of the door 2. For example, the closing device 4 may be mounted on the lower portion of the door 2.

A cover 235 may be provided at the lower portion of the door 2. The cover 235 may protrude downward from a lower surface of the door 2. The cover 235 may be positioned at the front of the catcher 5.

The cover 235 may be an exterior component that conceals a mechanical part exposed at the lower end of the door 2, and may provide aesthetic appearance and safety.

The cover 235 may be located rearward relative to the front surface 201 of the door 2.

Referring to FIG. 3, the door 2 may include a door liner 202 forming a rear surface. The door liner 202 may include a rearwardly protruding portion configured to be accommodated in the storage compartment when the door 2 is closed.

Hereinafter, the door liner 202 will also be referred to as the rear surface 202 of the door.

The front surface 201 of the door 2 may define an outer surface thereof, and the rear surface 202 of the door 2 may define an inner surface facing the storage compartment 11.

A gasket may be provided on the rear surface 202 of the door 2 to seal the storage compartment 11 when the door 2 is closed.

The filler 207 described above may be rotatably coupled to the rear surface 202 of the door 2.

The door 2 may include a lower cap deco 23 that forms a lower surface of the door 2. The lower cap deco 23 may be inserted between a lower end of the front surface 201 and a lower end of the rear surface 202 of the door 2.

The door 2 may include an upper cap deco that forms an upper surface of the door 2. The upper cap deco may be inserted between an upper end of the front surface 201 and an upper end of the rear surface 202 of the door 2.

In this manner, the door 2 may have a structure with an internal space, and the internal surface of the door 2 may be filled with an insulating material. Accordingly, when the door 2 closes the storage compartment 11, the storage compartment 11 may be thermally insulated from the outside. In a similar manner, an insulating material may be filled outside the storage compartment 11 of the cabinet 10 to thereby thermally insulate the storage compartment 11.

Hereinafter, the lower cap deco 23 will be referred to as a cap deco 23, and the description of the cap deco 23 may be identically or similarly applied to the upper cap deco.

According to an embodiment of the present disclosure, the refrigerator includes a hinge 3 to support the door 2. The hinge 3 may rotatably support the door 2. The hinge 3 may be fixed or secured to the cabinet 10, and may rotatably support the door 2 relative to the cabinet 10.

The hinge 3 may include a hinge shaft 31 that rotatably supports the door 2.

The hinge 3 may include a supporter 34 extending forward from the cabinet 10. The hinge shaft 31 may protrude vertically from the supporter 34.

The hinge 3 may include a mount 33 fixed to the cabinet 10. The mount 33 may be fixed to the cabinet 10 via a fastening member.

The supporter 34 may extend forward from the mount 33.

The hinge 3 may be provided at each of upper and lower sides of the door 2. The hinge 3 may be provided at each of upper and lower sides of the upper door 20. The hinge 3 may be provided at each of upper and lower sides of the lower door 25. The hinge provided at the lower side of the upper door 20 and the hinge provided at the upper side of the lower door 25 may have hinge shafts 31 protruding upward and downward from the single supporter 36. That is, the hinge shaft 31 protruding upward from the supporter 36 may support a lower end of the upper door 20 so as to rotatably support the upper door 20 relative to the cabinet 10, and the hinge shaft protruding downward from the supporter 36 may support an upper end of the lower door 25 so as to rotatably support the lower door 25 relative to the cabinet 10.

The door 2 may include a bushing 231 coupled to the hinge 3. The bushing 231 may be provided on the lower surface or the upper surface of the door 2.

Although the hinge 3 and the bushing 231 are illustrated in FIG. 3 as being provided at the lower side of the upper door 20, as described above, the hinge 3 may be provided at the upper side of the upper door 20 and the lower side of the lower door 25, and the features of the hinge 3 and the bushing 8 described in the present disclosure may also be applicable to the hinges and bushings provided at the upper side of the upper door 20 and the lower side of the lower door 25.

The bushing 231 may be provided at the cap deco 23. The bushing 231 may include a shaft insertion groove 232. The hinge shaft 31 may be inserted into the shaft insertion groove 232.

The bushing 231 may accommodate the hinge shaft 31. The bushing 231 may rotatably support the hinge shaft 31.

As the hinge shaft 31 rotates within the bushing 231, the door 2 may be opened and closed.

Meanwhile, the structure of the hinge 3 and the bushing 231 may be implemented as a so-called ‘path hinge’ in which the door moves and rotates along a predetermined path. For example, the door 2 may be rotatably provided at the front of the cabinet 10, and a position of a rotation center of the door 2 may vary depending on an opening degree of the door 2.

The shaft insertion groove 232 may rotatably support the hinge shaft 31. The opening and closing of the door 2 may be enabled as the hinge shaft 31 rotates and/or moves within the bushing 231.

The shaft insertion groove 232 of the bushing 231 may have a structure extending with a constant width. For example, the shaft insertion groove 232 may extend in a curved manner. For example, the shaft insertion groove 232 may have an arc shape. For example, the shaft insertion groove 232 may have a shape in which two arcs with different radii of curvature are connected to each other.

The shaft insertion groove 232 may include a first curved part in which the hinge shaft 31 is positioned when the door 2 is closed. The shaft insertion groove 232 may include a second curved part extending from the first curved part.

The second curved part may be disposed relatively closer to an outer end of the door 2, and the first curved part may be disposed relatively farther from the outer end of the door 2.

The second curved part may have a smaller radius of curvature than the first curved part.

A width of the shaft insertion groove 232 may correspond to an outer diameter of the hinge shaft 31. That is, the shaft insertion groove 232 may have a width equal to or slightly greater than the outer diameter of the hinge shaft 31, thereby allowing the hinge shaft 31 to slide along the shaft insertion groove 232.

Two or more hinge shafts may be provided for the shaft 31 of the hinge 3. For example, the hinge 3 may include two hinge shafts 31, which provides a rotation center for the door 2. In this case, a position of the rotation center of the door 2 may vary depending on an opening degree of the door 2. That is, when the door 2 is opened, the two hinge shafts 31 may slide along the shaft insertion groove 232 within the shaft insertion groove 232, thereby allowing the door 2 to rotate.

When the position of the rotation center of the door 2 is fixed, a front outer edge of the door 2 may move beyond a position of an outer end of the door 2 in the width direction in a closed state as the door 2 is opened.

In the case of the ‘path hinge’ structure of the hinge shaft 31 and the shaft insertion groove 232, the front outer edge of the door 2 may remain within, or may minimize a degree of deviation beyond, the position of the outer end of the door 2 in a closed state even when the door 2 is opened.

Accordingly, when another piece of furniture is placed beside the refrigerator, or when the refrigerator is disposed in an enclosure such that the refrigerator door does not protrude forward beyond the other furniture or the enclosure, the door may be opened without interfering with the other furniture or the enclosure.

The hinge 3 includes a reference pin 35. The reference pin 35 may be spaced apart from the hinge shaft 31.

The reference pin 35 may protrude from the supporter 36. The reference pin 35 may protrude upward from the supporter 36.

The reference pin 35 may be inserted into a slit 53 of the catcher 5. As the door 2 moves, the catcher 5 may move and rotate, and during this process, the reference pin 35 may slide within the slit 53.

The closing device 4 may be mounted to the cap deco 23. For example, the cap deco 23 may include a closing device accommodating portion recessed upward from the lower surface of the door 2, and the closing device 4 may be inserted into the closing device accommodating portion.

The closing device 4 may include the catcher 5 that is rotatably provided. The closing device 4 may rotate the catcher 5.

The catcher 5 may include the slit 53 into which the reference pin 25 is inserted. When the reference pin 35 is positioned in the slit 53, rotation of the catcher 5 may cause the door 2 to be closed. Or, when the reference pin 35 is positioned in the slit 53, rotation of the door 2 may cause the catcher 5 to rotate.

A recessed grip 236 may be provided on the lower surface of the door 2. The recessed grip 236 may be provided on the cap deco 23.

The recessed grip 236 may be recessed upward from the lower surface of the door 2. The recessed grip 236 may be positioned on an opposite side of the hinge 3 in the width direction of the door 2.

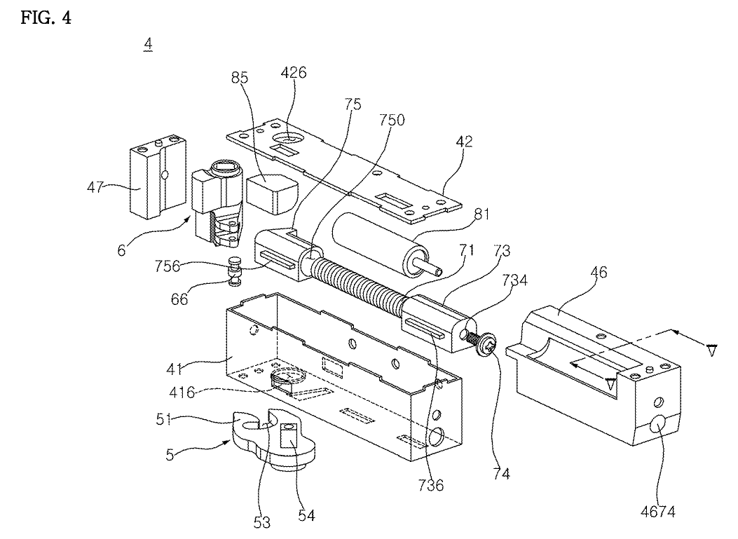

Referring to FIG. 4, the closing device 4 may include the catcher 5. The catcher 5 may include a finger 51 that defines the slit 53.

The catcher 5 may be configured to be rotatable. The catcher 5 may include a rotating shaft 54. The catcher 5 may rotate about the rotating shaft 54.

The closing device 4 may include a cam 6 configured to rotate integrally with the catcher 5. The rotating shaft 54 of the catcher 5 may be coupled to the cam 6. The rotating shaft 54 may have a non-circular outer periphery. For example, the rotating shaft 54 may have a polygonal prism shape. For example, the rotating shaft 54 may have a rectangular prism shape.

The closing device 4 may include an auto closing module 7 configured to rotate the catcher 5. The auto closing module 7 may provide a force in a door-closing direction when an angle between the cabinet 10 and the door 2 is equal to or less than a predetermined angle in an open state of the door 2.

The auto closing module 7 may rotate the cam 6. The auto closing module 7 may apply a force to the cam 6 to rotate the catcher 5.

A rotation center (or rotation axis) of the catcher 5 may be oriented vertically. A rotation center (or rotation axis) of the cam 6 may be oriented vertically.

The auto closing module 7 may be disposed in a direction intersecting the rotation center of the catcher 5. For example, the auto closing module 7 may be disposed horizontally. The auto closing module 7 may be disposed in the width direction (i.e., the left-right direction of FIG. 1) of the door 2.

The auto closing module 7 may include a spring 71.

The spring 71 may be arranged in a direction intersecting the rotation center of the catcher 5. For example, the spring 71 may be disposed horizontally. The spring 71 may be disposed in the width direction of the door 2.

The auto closing module 7 may include a holder 73. The holder 73 may be coupled to one end of the spring 71.

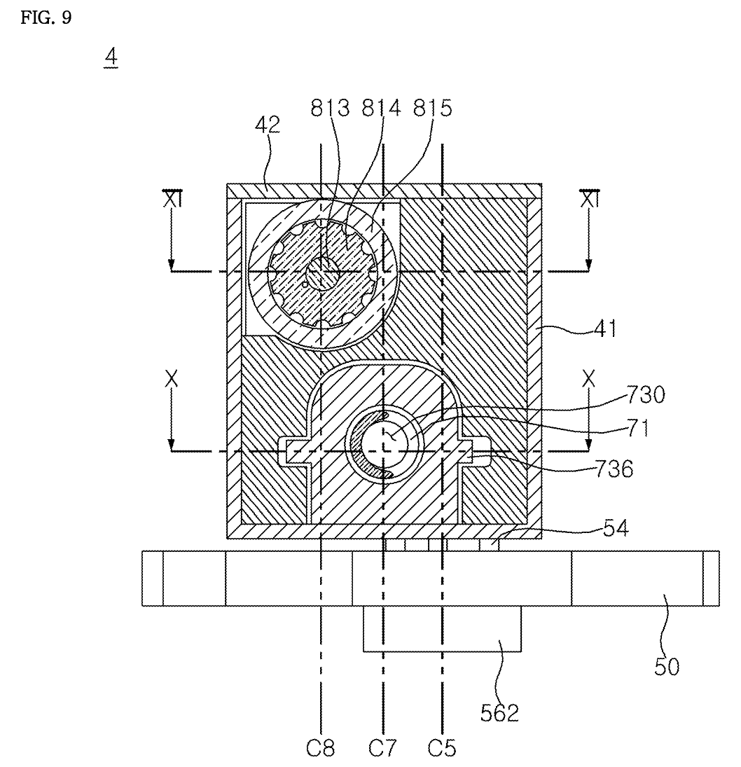

The holder 73 may include a spring accommodating groove 730 (see FIG. 9). One end of the spring 71 may be inserted into the spring accommodating groove 730.

The auto closing module 7 may include an actuator 75. The actuator 75 may be coupled to the other end of the spring 71.

The actuator 75 may include a spring accommodating groove 750. The other end of the spring 71 may be inserted into the spring accommodating groove 750.

The actuator 75 may be configured to be slidable along a longitudinal direction of the auto closing module 7. The actuator 75 may slide along a longitudinal direction of the spring 71.

The actuator 75 may contact the cam 6. The actuator 75 may contact the cam 6 to transmit an elastic force of the spring 71 to the cam 6.

The cam 6 may include a roller 66 that contacts the actuator 75. The roller 66 may roll along an outer surface of the actuator 75.

The closing device 4 may include a soft closing module 8 that provides a force in a door-opening direction when the door 2 closes. The soft closing module 8 may apply a force to the cam 6 in a direction opposite to that of the auto closing module 7.

The soft closing module 8 may include a damper 81. The damper 81 may provide a force applied to the cam 6.

The soft closing module 8 may include a head 85 that contacts the cam 6. The head 85 may contact a second arm 68 of the cam 6, which will be described later. The head 85 may be coupled or attached to the damper 81.

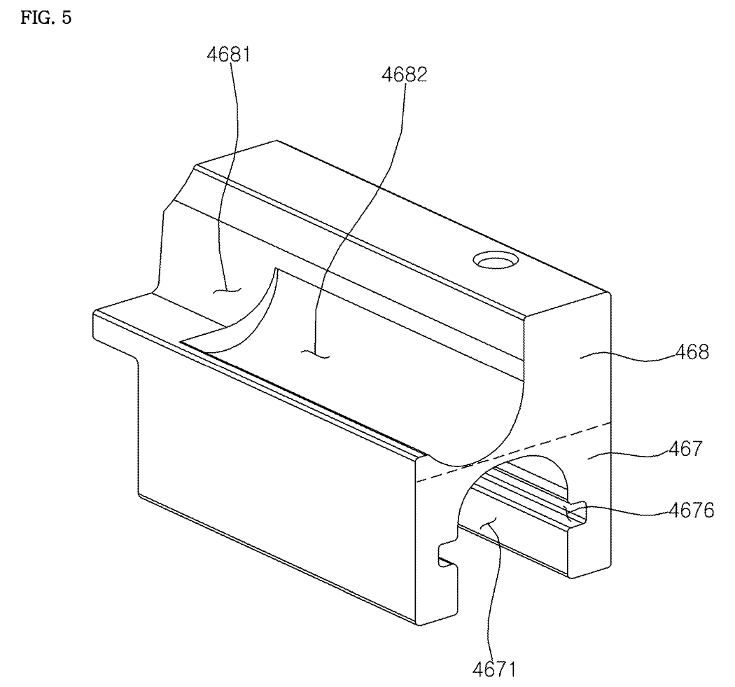

Referring to FIGS. 4 and 5, the closing device 4 may include a housing 46 in which the auto closing module 7 is accommodated. The housing 46 may accommodate the auto closing module 7 and the soft closing module 8.

The housing 46 may include an auto closing housing 467 to accommodate the auto closing module 7 and a soft closing housing 468 to accommodate the soft closing module 8. The auto closing housing 467 and the soft closing housing 468 may be formed as one body. That is, the housing 46 may be divided into the auto closing housing 467 and the soft closing housing 468.

The housing 48 may include an auto closing accommodating portion 4671 in which the auto closing module 7 is accommodated. The auto closing accommodating portion 4671 may be formed in the auto closing housing 467.

The auto closing accommodating portion 4671 may have a shape corresponding to the auto closing module 7. The auto closing accommodating portion 4671 may have a shape corresponding to an outer surface of the holder 73, and may extend along the longitudinal direction of the auto closing module 7.

In the longitudinal direction of the auto closing module 7, the auto closing accommodating portion 4671 may be open at one side and at least partially closed at the other side. The actuator 75 may be slidable into and out of the auto closing accommodating portion 4671 through the open side of the auto closing accommodating portion 4671.

The holder 73 may be accommodated in the housing 46. The holder 73 may be fixed to the housing 46.

The holder 73 may be supported at the closed side of the auto closing accommodating portion 4671.

The auto closing module 7 may include a force adjusting part 74. The force adjusting part 74 may adjust a position of the holder 71 in the longitudinal direction of the auto closing module 7. The force adjusting part 74 may adjust the position of the holder 73 relative to the housing 46. That is, when a position of the actuator 75 is fixed, for example, in a state where the actuator 75 contacts the cam 6 and the cam 6 does not rotate, the position of the holder 73 may be adjusted to change a distance between the actuator 75 and the holder 73. Accordingly, a compression length of the spring 71 and an elastic force thereof may be adjusted.

The holder 73 may be movable in the longitudinal direction of the auto closing module 7 by the force adjusting part 74. The holder 73 may include a slider 736. The slider 736 may protrude outward from an outer surface of the holder 73. The slider 736 may extend along the longitudinal direction of the auto closing module 7.

The housing 46 may include a guide groove 4676. The guide groove 4676 may be recessed outward from the auto closing accommodating portion 4671. The guide groove 4676 may extend along the longitudinal direction of the auto closing module 7.

The slider 736 of the holder 73 may be inserted into the guide groove 4676. The slider 736 may be moved along the guide groove 4676.

The actuator 75 may slide along the housing 46. The actuator 75 may include a slider 756. The slider 756 may protrude from an outer periphery of the actuator 75. The slider 756 may extend along the longitudinal direction of the auto closing module 7.

The slider 756 of the actuator 75 may be inserted into the guide groove 4676. The slider 756 may be moved along the guide groove 4676.

The closed side of the auto closing accommodating portion 4671 may have a completely closed shape or a partially open shape.

For example, a through-hole 4674 may be formed in the closed side of the auto closing accommodating portion 4671. The force adjusting part 74 may be adjusted through the through-hole 4674.

For example, the force adjusting part 74 may have a screw shape. A screw head of the force adjusting part 74 may be supported while being positioned at the closed side of the accommodating portion 4671, and may be exposed through the through-hole 4674.

A driver may be inserted into the through-hole 4674 to rotate the force adjusting part 74.

The holder 73 may include a screw groove 734 into which the force adjusting part 74 is inserted.

The force adjusting part 74 may be provided with a thread protruding outward, and the screw groove 734 may be provided with a thread corresponding thereto. When the force adjusting part 74 is rotated, a distance between the other side of the auto closing accommodating portion 4671 and the holder 73 may be adjusted.

The auto closing accommodating portion 4671 may be open toward the bottom.

The housing 46 may include a soft closing accommodating portion 4681. The soft closing module 8 may be disposed in the soft closing accommodating portion 4681.

The soft closing accommodating portion 4681 may be formed in the soft closing housing 468.

The soft closing accommodating portion 4681 may be open toward the top.

The soft closing accommodating portion 4861 may include a damper seating groove 4682. The damper seating groove 4682 may be recessed downward. The damper 81 may be seated on the damper seating groove 4682.

Referring to FIG. 4, the closing device 4 may include a cam support 47. The housing 46 may be positioned at one side of the cam 6, and the cam support 47 may be positioned at the other side of the cam 6.

The housing 46 may be located with respect to the cam 6 in a first rotational direction of the cam 6. The first rotational direction may be a direction in which the cam 6 rotates when the door 2 closes.

The cam support 47 may be located with respect to the cam 6 in a second rotational direction of the cam 6. The second rotational direction may be a direction in which the cam 6 rotates when the door 2 is opened. The second rotational direction may be opposite to the first rotational direction.

The closing device 4 may include a case 41. The cam 6, the auto closing module 7, and the soft closing module 8 may be disposed within the case 41. The housing 46 may be disposed within the case 41. The cam support 47 may be disposed within the case 41.

The closing device 4 may include a case cover 42. The case 41 may be open at an upper side, and the case cover 42 may cover the open upper side of the case 41.

The case cover 42 may include an upper shaft support portion 426. An upper end of the cam 6 may be inserted into the upper shaft support portion 426.

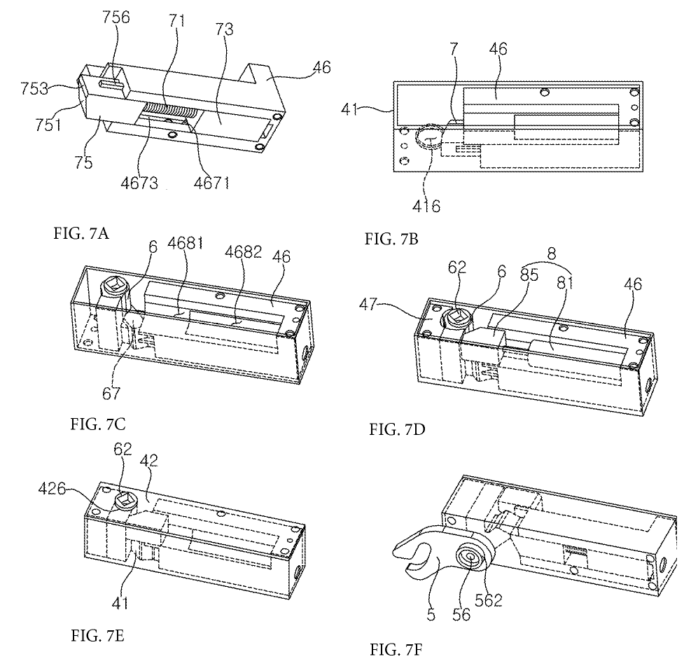

The case 41 may include a lower shaft support portion 416 (see FIGS. 7A - 7F). A lower end of the cam 6 may be inserted into the lower shaft support portion 416.

The upper shaft support portion 426 and the lower shaft support portion 416 may rotatably support the cam 6.

The catcher 5 may be disposed below the case 41. The rotating shaft 54 of the catcher 5 may pass through a lower surface of the case 41 and be coupled to the cam 6. The catcher 5 may be coupled to the cam 6 through the lower shaft support portion 416.

The case 41 may be mounted to the door 2. The case 41 may be mounted to the door 2.

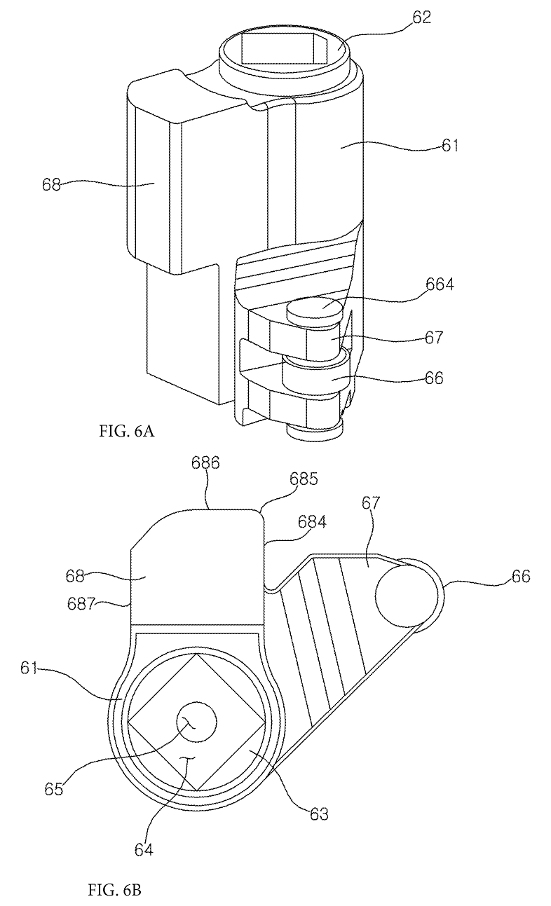

The cam 6 will be described with reference to FIG. 6A of FIGS. 6A and 6B illustrates a perspective view of the cam 6, and FIG. 6B illustrates a bottom view of the cam 6. Referring to FIGS. 6A and 6B, the cam 6 may include a hub 61 surrounding a rotation center thereof. The cam 6 may include an upper cam shaft 62 provided at an upper end of the hub 61. The cam 6 may include a lower cam shaft 63 provided at a lower end of the hub 61.

The upper cam shaft 62 may protrude upward from the hub 61. The upper cam shaft 62 may be coupled to the upper shaft support portion 426 of the case cover 42. The upper cam shaft 62 may be inserted into the upper shaft support portion 426.

The lower cam shaft 63 may protrude downward from the hub 61. The lower cam shaft 63 may be coupled to the lower shaft support portion 416 of the case 41. The lower cam shaft 63 may be inserted into the lower shaft support portion 416.

The upper cam shaft 62 and the lower cam shaft 63 may provide a rotation center (or rotation axis) of the cam 6. The cam 6 may rotate about the rotation center extending between the upper cam shaft 62 and the lower cam shaft 63.

The cam 6 may include a shaft coupling portion 64. The rotating shaft 54 of the catcher 5 may be inserted into the shaft coupling portion 64.

The shaft coupling portion 64 and the rotating shaft 54 of the catcher 5 may have shapes corresponding to each other. The shaft coupling portion 64 and the rotating shaft 54 of the catcher 5 may have a non-circular shape. For example, the rotating shaft 54 of the catcher 5 may have a polygonal prism shape, and the shaft coupling portion 64 may be recessed into a polygonal prism shape. For example, the rotating shaft 54 of the catcher 5 may have a rectangular prism shape, and the shaft coupling portion 64 may be recessed into a rectangular prism shape.

The shaft coupling portion 64 may be provided at a lower portion of the cam 6. The shaft coupling portion 64 may be located at the rotation center of the cam 6. The shaft coupling proton 64 may be recessed upward from the hub 61. The shaft coupling portion 64 may be recessed upward from the lower shaft support portion 63.

The cam 6 may include a shaft fastening hole 65. The shaft fastening hole 65 may be formed in the shaft coupling portion 64.

A fastening member may pass through a fastening hole 56 of the catcher 5 and be inserted into the shaft fastening hole 65 of the cam 6 so as to couple the catcher 5 and the cam 6.

The cam 6 may include a first arm 67. The first arm 67 may protrude in a radial direction of the cam 6. The first arm 67 may protrude radially outward from the rotation center of the cam 6. The first arm 67 may protrude radially outward from the hub 61. The first arm 67 may protrude toward the auto closing module 7.

The first arm 67 may contact the auto closing module 7. The first arm 67 may contact the actuator 75.

The first arm 67 may directly contact the auto closing module 7, or another component provided at the first arm 67 may contact the auto closing module 7.

For example, the cam 6 may include the roller 66 provided on the first arm 67. The roller 66 may contact the auto closing module 7.

The roller 66 may be rotatably coupled to the first arm 67. A rotating shaft 664 of the roller 66 may be coupled to the first arm 67.

The first arm 67 may interact with the auto closing module 7. For example, the auto closing module 7 may push the first arm 67 to rotate the cam 6.

The cam 6 may include the second arm 68. The second arm 68 may protrude in a radial direction of the cam 6. The second arm 68 may protrude in a radial direction different from that of the first arm 67. That is, a longitudinal center line of the first arm 67 and a longitudinal center line of the second arm 68 may be circumferentially spaced apart from each other about the rotation center of the cam 6.

The second arm 68 may be disposed between the first arm 67 and the cam support 47 in the circumferential direction. When viewed from above, the second arm 68 may be disposed between the first arm 67 and the cam support 47 in the circumferential direction.

The second arm 68 may protrude radially outward from the rotation center of the cam 6. The second arm 68 may protrude radially outward from the hub 61. The second arm 68 may protrude toward the soft closing module 8.

The second arm 68 may contact the soft closing module 8. The second arm 68 may contact the head 85.

The second arm 68 may include a first surface 686 defining a radial outer end.

The second arm 68 may include a second surface 684 extending radially. The second surface 684 may extend from the hub 61 to the first surface 686. The second surface 684 may be directed toward the soft closing module 8 in the circumferential direction. The second surface 684 may be directed toward the first arm 67 in the circumferential direction.

An edge 685 may be formed between the first arm 686 and the second arm 684. The edge 685 between the first and second arms 686 and 684 may be formed with a curvature.

When the door 2 is closes, the second surface 684 or the edge 685 may contact the head 85. When the auto closing module 7 rotates the cam 6 such that the second surface 684 or the edge 685 comes into contact with the head 85, a closing speed of the door 2 may be reduced by a damping force of the soft closing module 8.

In a closed state of the door 2, the second surface 684 may contact the housing 46. Accordingly, even when the auto closing module 7 applies a force to the cam 6, the cam 6 may no longer rotate in the closed state of the door 2.

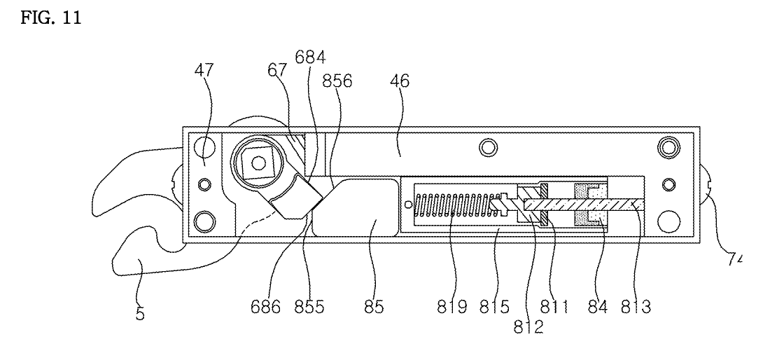

In a closed state of the door 2, the first surface 686 may contact an inclined surface 856 of the head 85 (see FIG. 11). Accordingly, no damping force of the soft closing module 8 may be applied to the cam 6 in the closed state of the door 2.

The second arm 68 may include a third surface 687 extending radially. The third surface 687 may extend from the hub 61 to the first surface 686. The third surface 687 may be spaced apart from the second surface 684. The third surface 687 may extend parallel to the second surface 684.

The third surface 687 may support the cam support 47 in the circumferential direction. In an open state of the door 2, the third surface 687 may contact the cam support 47. In a state where the door 2 is open and the reference pin 35 is located outside the slit 53, the third surface 687 may contact the cam support 47. In this state, even when the auto closing module 7 pushes the cam 6, the cam 6 may not rotate due to the cam support 47.

An assembly process of the closing device 4 will be described with reference to FIGS. 7A - 7F. Referring to FIG. 7A, an assembler inserts the auto closing module 7 into the auto closing accommodating portion 4671 of the housing 46. After the holder 73 is inserted, the actuator 75 is inserted. When inserting the auto closing module 7 into the auto closing accommodating portion 4671, the sliders 736 and 756 may be inserted into the guide groove 4673.

The auto closing module 7 is inserted into the auto closing accommodating portion 4671 such that an acting surface 751 of the actuator 75 is located at the rear and a locking surface 753 is located at the front. Here, a side where the soft closing module accommodating portion 4861 is disposed at an upper portion of the housing 46 may be defined as the front.

Referring to FIG. 7B, the assembler inserts the housing 46 coupled with the auto closing module 7 into the case 41. The auto closing module 7 and the housing 46 are inserted into the case 41 such that the lower shaft support portion 416 of the case 41 is exposed.

Referring to FIG. 7C, the cam 6 is mounted on the case 41. The lower cam shaft 63 of the cam 6 is inserted into the lower shaft support portion 416.

Referring to FIGS. 7C and 7D, the cam support 47 is inserted into a space between the cam 6 and a wall of the case 41. The soft closing module 8 is mounted on the soft closing accommodating portion 4681. The soft closing module 8 may be mounted after inserting the cam support 47, or the cam support 47 may be inserted after the soft closing module 8 is mounted, or both may be installed simultaneously.

When inserting the soft closing module 8, the damper 81 may be seated on the damper seating groove 4682.

The head 85 of the soft closing module 8 may be coupled to a piston rod 813 of the damper 81 or a cylinder 815.

Referring to FIG. 7E, the case cover 42 may be coupled to the case 41. The upper cam shaft 62 of the cam 6 may be inserted into the upper shaft support portion 426 of the case cover 42.

Referring to FIG. 7F, the rotating shaft 54 of the catcher 5 is inserted into the shaft coupling portion 64 of the cam 6, and a fastening member is fastened to the fastening hole 56 so as to couple the catcher 5 and the cam 6. When the fastening member is inserted, the fastening member may not be exposed at the front due to a rim 562.

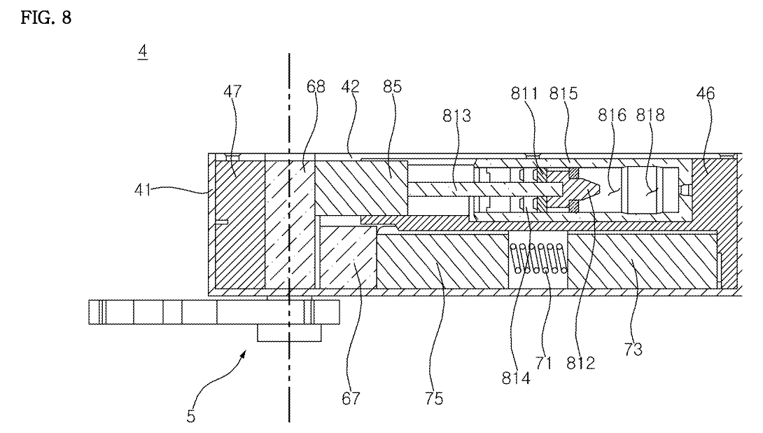

Referring to FIG. 8, a rotation center (or rotation axis) of the catcher 5 may be oriented vertically. A rotation center (or rotation axis) of the cam 6 may be oriented vertically.

The auto closing module 7 may be disposed in a direction intersecting the rotational center of the catcher 5 or the cam 6. The auto closing module 7 may be disposed horizontally.

The spring 71 of the auto closing module 7 may be disposed in a direction intersecting the rotational center of the catcher 5 or the cam 6. The spring 71 may be disposed horizontally.

The actuator 75 may slide in a direction intersecting the rotational center of the catcher 5 or the cam 6. The actuator 75 may slide horizontally.

The auto closing module 7 may apply a force to the first arm 67 of the cam 6 to rotate the cam 6 and the catcher 5.

The second arm 68 may contact the cam support 47 in a closed state of the door 2.

Referring to FIGS. 8 and 11, the soft closing module 8 may be disposed in a direction intersecting the rotational center of the catcher 5 or the cam 6. The soft closing module 8 may be disposed horizontally.

The damper 81 of the soft closing module 8 may be disposed in a direction intersecting the rotational center of the catcher 5 or the cam 6. The damper 81 may be disposed horizontally.

The damper 81 may include a cylinder 815 and a piston 811 disposed inside the cylinder 815. The piston 811 may have a disk shape.

The damper 81 may include a piston rod 813.

The cylinder 815 may be closed at a side opposite to the piston rod 813. A space between the piston 811 and the cylinder 815 may be sealed.

The damper 81 may include a bush 814. The bush 814 may be disposed at an open side of the cylinder 815. The bush 815 may support the piston rod 813. The bush 815 may slidably support the piston rod 813.

The head 85 may be coupled to the piston rod 813 or the cylinder 815. For example, as shown in FIG. 8, the head 85 may be coupled to the piston rod 813, and the cylinder 815 may be fixed to the housing 46. In another example, as shown in FIG. 11, the head 85 may be coupled to the cylinder 815, and the piston rod 813 may be coupled to the housing 46.

The head 85 may slide in a direction intersecting the rotation center of the catcher 5 or the cam 6. The head 85 may slide horizontally.

When the cam 6 rotates, the second arm 68 may push the head 85. When the head 85 slides and the damper 81 is compressed, the soft closing module 8 may apply a force to the cam 6 in a direction opposite to the force applied by the auto closing module 7.

When the cam 6 causes the head 6 to slide and a distance between the piston 811 and a closed side of the cylinder 815 becomes smaller, the sealed space may be compressed. In this process, the soft closing module 8 may apply a force to the cam 6 in a direction opposite to a direction in which the cam 6 rotates.

The cylinder 815 may include a first section 816 and a second section 818. An inner diameter of the first section 816 may be less than or equal to an outer diameter of the piston 811. An inner diameter of the second section 818 may be greater than the outer diameter of the piston 811.

Accordingly, when the piston 811 is located in the first section 816, the space between the piston 811 and the cylinder 815 may be sealed, and when the damper 81 is compressed, a damping force may be provided to the cam 6. When the piston 811 is located in the second section 818, the sealed space may communicate with the outside, and the damping force of the damper 81 may be released.

The damper 81 may include a spring 819. The spring 819 may be positioned between the piston 811 and the closed wall of the cylinder 815.

The damper 81 may include a connector 812. One end of the spring 81 of the damper 81 may be connected to the connector 812, and the other end thereof may be connected to the cylinder 815.

Referring to FIGS. 8 and 9, the auto closing module 7 and the soft closing module 8 may be disposed within the single case 41. The auto closing module 7 and the soft closing module 8 may interact with the single cam 6. The cam 6, the auto closing module 7, and the soft closing module 8 may be disposed within the single case 41 so that the closing device 4 is modalized as an integrated unit.

The auto closing module 7 may be disposed above or below the soft closing module 8. For example, the auto closing module 7 may be disposed below the soft closing module 8.

In a front-rear direction or a width direction of the closing device 4, a center C7 of the auto closing module 7 and a center C8 of the soft closing module 8 may be spaced apart from a rotation center (or rotation axis) C5 of the catcher 5 or the cam 6. The longitudinal center C7 of the auto closing module 7 and the longitudinal center C8 of the soft closing module 8 may be spaced apart from the rotation center of the catcher 5 or the cam 6 toward the front of the door 2.

Accordingly, a space in which the first and second arms 67 and 68 rotate may be secured.

In the front-rear direction or the width direction of the closing device 4, the center C7 of the auto closing module 7 and the center C8 of the soft closing module 8 may be spaced apart from each other.

For example, with respect to the center C7 of the auto closing module 7, the center C8 of the soft closing module and the rotation center C5 of the catcher 5 or the cam 6 may be located opposite each other. The center C7 of the auto closing module 7 may be located at the middle of the case 41 in the front-rear direction or the width direction of the closing device 4.

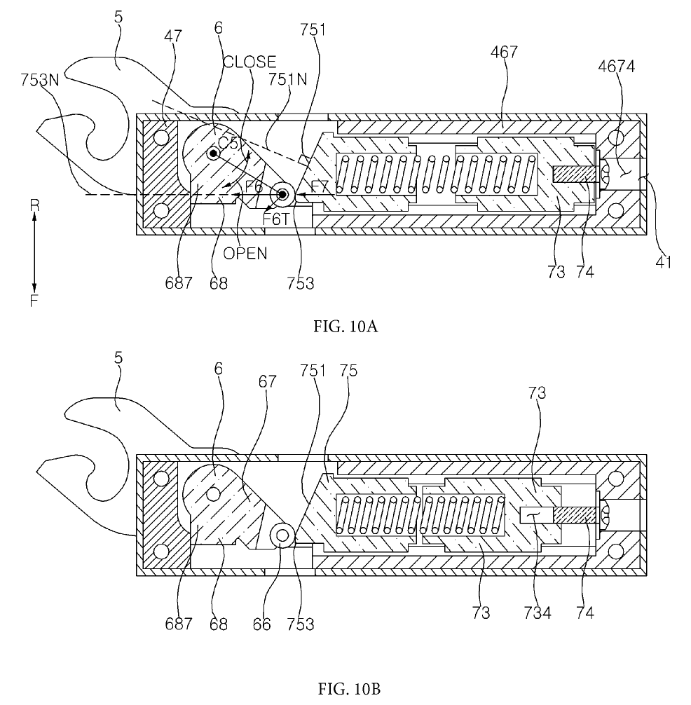

Referring to FIGS. 10A and 10B, the actuator 75 may contact the cam 6. The actuator 75 may contact the second arm 67 or the roller 66 of the cam 6.

The actuator 75 may include an acting surface 751 inclined with respect to the width direction of the closing device 4. For example, the catcher 5 may be located relatively rearward when the door 2 is open and located relatively forward when the door 2 is closed, and the acting surface 751 may be inclined such that it becomes farther from the cam 6 toward the rear.

When the cam 6 contacts the acting surface 751, the auto closing module 7 may apply a force to the cam 6 in a normal direction of the acting surface 751. When the cam 6 contacts the acting surface 751, the auto closing module 7 may rotate the cam 5 such that the second arm 67 faces toward the rear and the catcher 5 rotates toward the front. That is, the auto closing module 7 may rotate the catcher 5 and the cam 6 in a CLOSE direction indicated in FIGS. 10A and 10B. When the catcher 5 rotates in the CLOSE direction, the catcher 5 may apply a force to the reference pin 35 located in the slit 53, thereby applying a force to the door 2 in a direction in which the door 2 is closed.

In a closed state of the door 2, the cam 6 may contact the acting surface 751. When the door 2 is opened, the reference pin 35 may slide along the slit 53, the catcher 5 may rotate in an OPEN direction indicated in FIGS. 10A and 10B, and the cam 6 may also rotate in the OPEN direction.

The CLOSE direction may be referred to as a first rotational direction of the cam 6, and the OPEN direction may be referred to as a second rotational direction of the cam 6.

When the door 2 is opened, the catcher 5, the cam 6, and the auto closing module 7 may be in a state as shown in FIG. 10A.

The actuator 75 may include a locking surface 753. The locking surface 753 may extend forward from the acting surface 751. The locking surface 753 may be inclined with respect to the acting surface 751.

The locking surface 753 may be directed toward the rotation center C5 of the cam 6. That is, the rotation center C5 of the cam 6 may intersect a normal of the locking surface 753.

Alternatively, the locking surface 753 may be directed toward the longitudinal direction of the auto closing module 7. The rotation center C5 of the cam 6 may be located between a normal 753N of the locking surface 753 and a normal 751N of the acting surface 751.

Alternatively, the locking surface 753 may be directed toward the space between the rotation center C5 of the cam 6 and the longitudinal direction of the auto closing module 7. Alternatively, the locking surface 753 may face a side opposite to the rotation center C5 of the cam 6 with respect to the longitudinal direction of the auto closing module 7. Hereinafter, a case in which the locking surface 753 is directed toward the longitudinal direction of the auto closing module 7 will be described as an example.

When the door 2 is opened and the reference pin 35 is released (or disengaged) from the slit 53, the second arm 67 or the roller 66 may come into contact with the locking surface 753 of the actuator 65.

By an elastic force of the spring 71, the actuator 75 may apply a force F7 to the cam 6. A tangential component F6T of a force F6 applied to the cam 6 may be directed toward the OPEN direction of the cam 6. Accordingly, the cam 6 may not rotate in the CLOSE direction.

The cam support 47 may be located with respect to the cam 6 in the second rotational direction (OPEN). The second rotational direction (OPEN) may be a direction in which the cam 6 rotates when the door 2 is opened. The second rotational direction (OPEN) may be a direction opposite to the first rotational direction (CLOSE) in which the cam 6 rotates when the door 2 closes.

The third surface 687 of the second arm 68 may contact the cam support 47. Accordingly, the cam 6 may not rotate in the OPEN direction.

Accordingly, a position of the cam 6 may be fixed.

Referring to FIGS. 10A and 10B, the auto closing module 7 may further include the force adjusting part 74 that adjusts a position of the holder 73 relative to the housing 46.

The force adjusting part 74 may have a screw shape. A screw portion of the force adjusting part 74 may be inserted into the screw groove 734 of the holder 73, and a screw head may be supported by the housing 46.

The holder 73 may include the screw groove 734 into which the force adjusting part 74 is inserted. The force adjusting part 74 may be inserted into the screw groove 734.

A thread protruding outward may be formed on the force adjusting part 74, and a thread corresponding thereto may be formed on the screw groove 734. By rotation of the force adjusting part 74, a distance between the other side of the auto closing accommodating portion 4671 and the holder 73 may be adjusted.

A through-hole 417 of the case 41 may be formed at a position corresponding to the through-hole 4674 of the housing 46.

The screw head of the force adjusting part 74 may be exposed through the through-holes 4674 and 417. The force adjusting part 74 may be adjusted through the through-holes 4674 and 417. For example, a driver may be inserted into the through-holes 4674 and 417 to rotate the force adjusting part 74.

The holder 73 may be moved in the longitudinal direction of the auto closing module 7 by the force adjusting part 74. When the holder 73 moves, the holder 73 may be supported by the slider 736 and the guide groove 4676.

The force adjusting part 74 may adjust the position of the holder 71 in the longitudinal direction of the auto closing module 7.

That is, when a position of the actuator 75 is fixed, for example, in a state where the actuator 75 contacts the cam 6 and the cam 6 does not rotate, the position of the holder 73 may be adjusted to change a distance between the actuator 75 and the holder 73. Accordingly, a compression length of the spring 71 and an elastic force thereof may be adjusted.

Referring to FIG. 11, the second arm 68 of the cam 6 may contact the soft closing module 8. The second arm 68 may contact the head 85.

The second arm 68 may include a first surface 686 defining a radial outer end. The second arm 68 may include a second surface 684 extending radially. An edge 685 may be formed between the first arm 686 and the second arm 684.

The head 85 may include a cam contact surface 855 directed toward a longitudinal direction of the soft closing module 8.

When the door 2 closes, the second surface 684 or the edge 685 may contact the cam contact surface 855 of the head 85. When the auto closing module 7 rotates the cam 6 such that the second surface 684 or the edge 685 comes into contact with the head 85, a closing speed of the door 2 may be reduced by a damping force of the soft closing module 8.

In a closed state of the door 2, the second surface 684 may contact the housing 46. Accordingly, even when the auto closing module 7 applies a force to the cam 6, the cam 6 may no longer rotate in the closed state of the door 2.

The head 85 may include an inclined surface 856 extending from the cam contact surface 855. The inclined surface 856 may be inclined with respect to the longitudinal direction of the soft closing module 8. For example, the inclined surface 856 may be inclined such that it becomes closer to the damper 81 toward the rear. The inclined surface 856 may be directed toward the rotational center of the cam 6.

In a closed state of the door 2, the first surface 686 may contact the inclined surface 856 of the head 85. Accordingly, no damping force of the soft closing module 8 may be applied to the cam 6 in the closed state of the door 2.

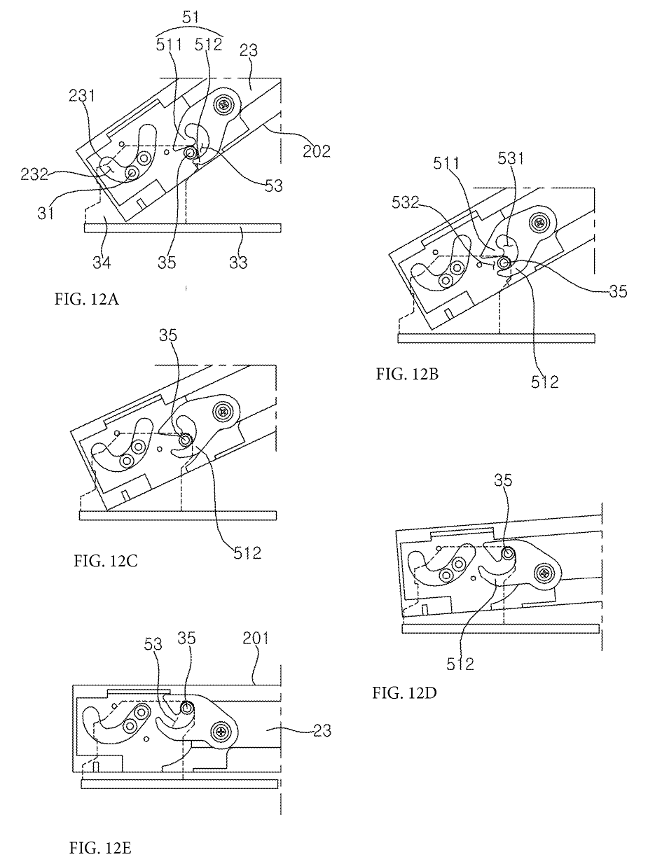

An operation of the closing device 4 according to opening and closing of the door 2 will be described with reference to FIGS. 12A - 12E and 13.

Referring to FIGS. 12A - 12E, a position of the hinge shaft 31 may be fixed relative to the cabinet 10, but a position of the bushing 231 may change as the door 2 is opened. Accordingly, the hinge shaft 31 may slide along the shaft insertion groove 232.

The catcher 5 may include the finger 51 defining the slit 53. The finger 51 may include a first finger 511 positioned at the front of the slit 53 and a second finger 512 positioned at the rear of the slit 53. The slit 53 may be positioned between the first and second fingers 511 and 512.

The catcher 5 may be positioned between the front surface 201 and the rear surface 202 of the door 2. The first finger 511 may be located rearward relative to the front surface 201. The second finger 512 may be located forward relative to the rear surface 202.

Even when the catcher 5 rotates rearward, a rear end of the catcher 5 may be located forward relative to the rear surface 202 of the door 2 (see FIG. 12A). Even when the catcher 5 rotates forward, a front end of the catcher 5 may be located forward relative to the front surface 202 of the door 2 (see FIG. 12E).

FIG. 12A shows a state in which the reference pin 35 is located at an outer end of the slit 53, and FIG. 12E shows a state in which the door 2 is closed and the reference pin 35 is located at an inner end of the slit 53. FIGS. 12B - 12D are intermediate states between (a) and (e), and the door 2 may be closed in the order of (a), (b), (c), (d), and (e). Conversely, the door 2 may be opened in the order of (e), (d), (c), (b), and (a).

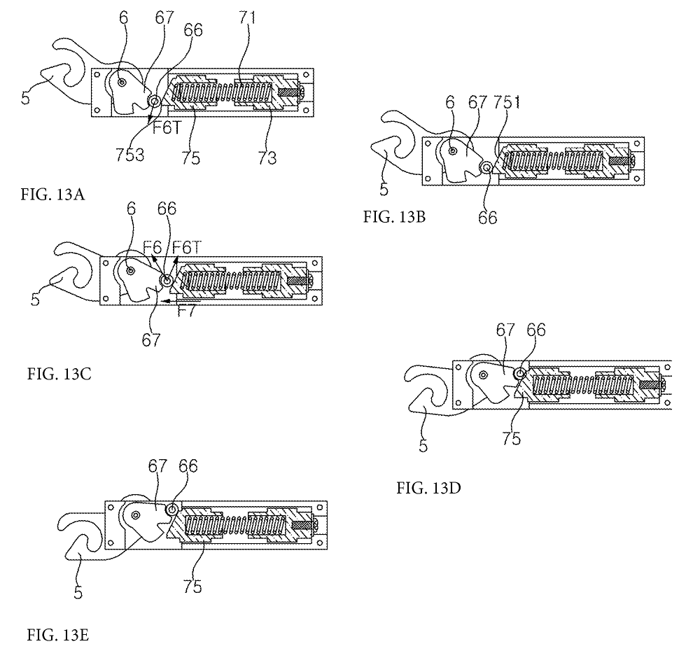

FIGS. 13A - 13E illustrate the auto closing module 7 according to the degree of opening of the door 2, and FIGS. 13A - 13E respectively illustrate the auto closing module 7 in the door-opening states shown in FIGS. 12A - 12E.

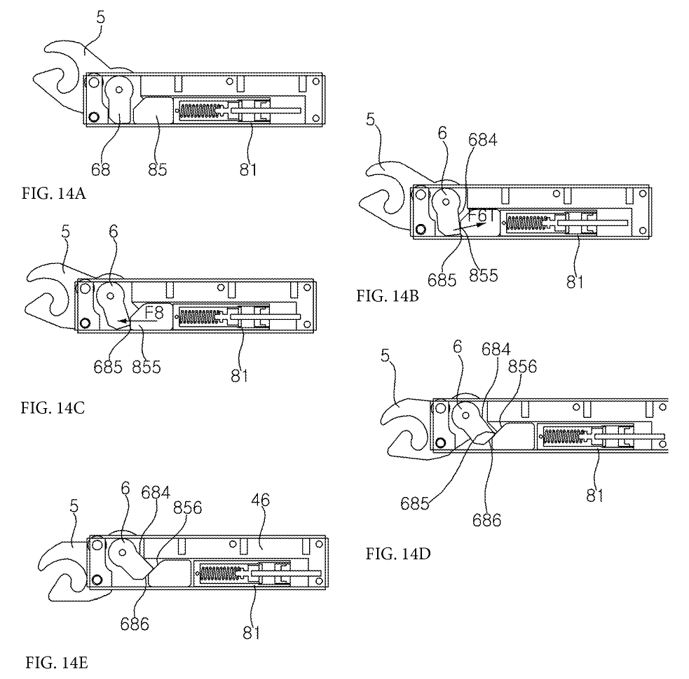

FIGS. 14A - 14E illustrate the soft closing module 8 according to the degree of opening of the door 2, and FIGS. 14A - 14E respectively illustrate the soft closing module 8 in the door-opening states shown in FIGS. 12A - 12E.

FIGS. 12A - 12E are bottom views, and FIGS. 13A - 13E and 14 are cross-sectional views seen from above, and therefore, the rotational direction of the catcher in FIGS. 12A - 12E is opposite to the rotational direction of the catcher and the cam in FIGS. 13A - 13E and 14. Hereinafter, a clockwise direction in FIGS. 12A - 12E and a counterclockwise direction in FIGS. 13A - 13E and 14 will be referred to as a first rotational direction, and a counterclockwise direction in FIGS. 12A - 12E and a clockwise direction in FIGS. 13A - 13E and 14 will be referred to as a second rotational direction.

Referring to FIGS. 12A, 13A, and 14A, when the door 2 is opened further than the state of FIG. 12A, the reference pin 35 may be located outside the slit 53.

In a state where the reference pin 35 is located outside the slit 53 or located at the outer end of the slit 53, the second arm 67 or the roller 66 of the cam 6 may contact the locking surface 753 of the actuator 75. As the auto closing module 7 presses the cam 6, a tangential component F6T of a force applied to the cam 6 is directed toward the second rotational direction (clockwise direction), and the cam support portion 46 is located in the second rotational direction of the cam 6, a position of the catcher 5 may be fixed.

Since the position of the catcher 5 is fixed with respect to the door 2, when the door 2 gradually closes from its open state and reaches the state of (a), the reference pin 35 may be located at the outer end of the slit 53.

When the reference pin 35 is located outside the slit 53 or located at the outer end of the slit 53, the second arm 68 of the cam 6 and the head 85 of the soft closing module 8 may be spaced apart from each other. Accordingly, even when the catcher 5 rotates in the first rotational direction, no damping force is applied.

When the door 2 is further closed, the first finger 51 may press the reference pin 35, and since the reference pin 35 is fixed, the catcher 5 may rotate in the first rotational direction (clockwise direction in FIGS. 12A and 12E).

FIGS. 12B - 12D - 14 illustrate states in which the catcher 5 and the cam 6 are rotated as the door 2 closes, and the roller 66 contacts the acting surface 751. The spring 71 may apply a force F7 to the actuator 75, and the actuator 75 may apply a force F6 in a normal direction of the acting surface 751. By a tangential component of the force F6 applied to the cam 6, the cam 6 and the catcher 5 may rotate in the first rotational direction.

As the cam 6 rotates in the first rotational direction, the second surface 684 of the second arm 68 or the edge 685 may press the head 85. The second surface 684 of the second arm 68 or the edge 685 may contact and press the cam contact surface 855. As the cam 6 rotates, the edge 685 may contact the inclined surface 856.

When the cam 6 rotates and pushes the head 85, the soft closing module 8 may apply a damping force F8 to the cam 6 to decrease the speed of the cam 6.

FIGS. 12E - 14 illustrate a closed state of the door 2. The hinge shaft 31 may be located at an inner end of the shaft insertion groove 232.

The reference pin 35 may be located at the inner end of the slit 53.

As the second surface 684 of the second arm 68 contacts the housing 46, rotation of the cam 6 may be restricted even when the first arm 67 does not contact the case 41 or the housing 46.

A portion of the housing 46 that contacts the second surface 684 may be referred to as a cam stopper. The cam stopper may be located on the second rotational direction side with respect to the second arm 68, and may contact the second arm 68 when the door 2 is closed.

As the first surface 686 of the second arm 68 contacts the inclined surface 856 of the head 85, a damping force may not be applied to the cam 6.

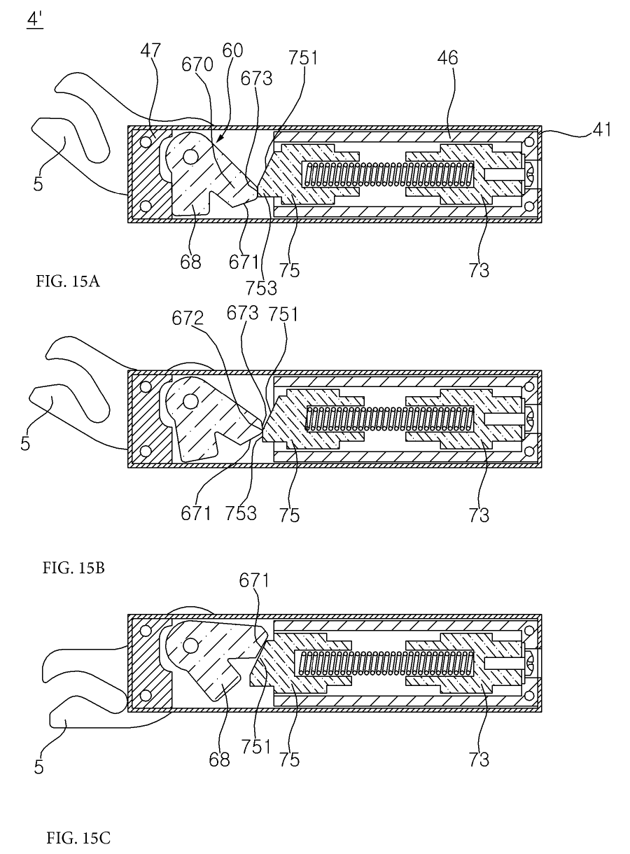

Hereinafter, a closing device 4’ of a refrigerator according to a second embodiment of the present disclosure will be described with reference to FIGS. 15A - 15C.

Referring to FIGS. 15A - 15C, the closing device 4’ of the refrigerator according to the second embodiment differs from the closing device 4 of the refrigerator according to the first embodiment in that the roller 66 is not provided. In the following description, features identical or similar to those of the first embodiment described above will be briefly described or detailed descriptions thereof will be omitted.

A case 41, a housing 46, a cam support 47, a catcher 5, an auto closing module 7, and a soft closing module 8 of this embodiment may be identical to the case 41, the housing 46, the cam support 47, the catcher 5, the auto closing module, and the soft closing module 8 of the first embodiment described above.

A cam 60 may include a first arm 670 facing the auto closing module 7 and a second arm 68 facing the soft closing module 8. The second arm 68 of this embodiment may be identical to the second arm 68 of the first embodiment described above.

The first arm 670 may include an opposing surface 673. The opposing surface 673 may contact the locking surface 753 of the actuator 75 when the reference pin 35 is located outside the slit 53.

The first arm 67 may include an inner surface 671 located at the second rotational direction side of the opposing surface 673. Hereinafter, the opposing surface 673 will also be referred to as an outer surface 673.

The first arm 67 may include a boundary portion 672 between the inner surface 671 and the outer surface 673.

When the catcher 5 rotates by the reference pin 35 and the cam 6 rotates as the door 2 closes, the opposing surface 673 may be spaced apart from the locking surface 753, and the boundary portion 672 may pass the locking surface 753 and be located at the acting surface 751. The acting surface 751 may apply a force to the boundary portion 672 or the inner surface 671 to rotate the cam 6 and the catcher 5, allowing the door 2 to be closed.

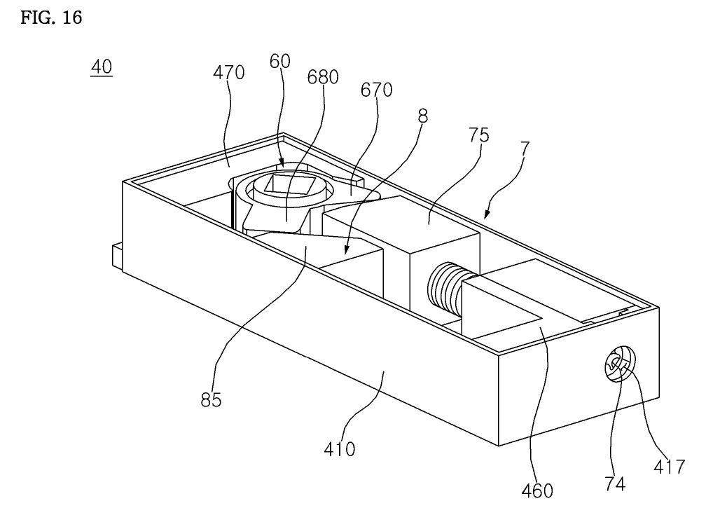

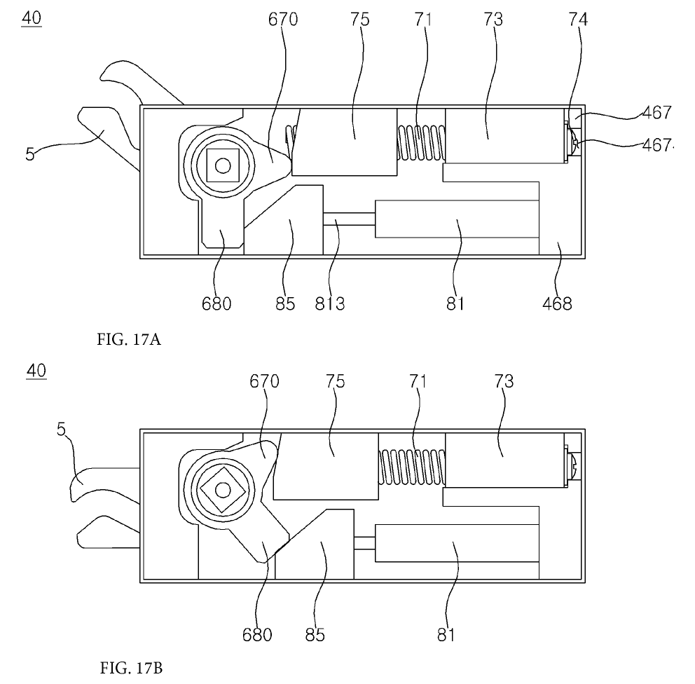

FIG. 16 is a perspective view of a closing device 40 of a refrigerator according to a third embodiment of the present disclosure, and FIGS. 17A and 17B are plan views of the closing device 40 of the refrigerator according to the third embodiment of the present disclosure, in which FIG. 17A illustrates an open state of the door 2, and FIG. 17B illustrates a closed state of the door 2. Hereinafter, the closing device 40 of the refrigerator according to the third embodiment of the present disclosure will be described with reference to FIGS. 16 and 17A and 17B.

Referring to FIGS. 16 and 17A and 17B, compared to the closing device 4 of the first embodiment described above, the closing device 40 of this embodiment differs in that an auto closing module 7 and a soft closing module 8 are arranged laterally instead of being arranged vertically. In the following description, features identical or similar to those of the first embodiment described above will be briefly described or detailed descriptions thereof will be omitted.

The closing device 40 may include a case 410. The auto closing module 7 and the soft closing module 8 may be disposed in the case 410.

The auto closing module 7 may include a spring 71, a holder 73, and an actuator 75. The auto closing module 7 may include a force adjusting part 74. A housing 460 and the case 410 may be provided with through-holes 4674 and 417, respectively. The structure and function of the auto closing module 7 of this embodiment may be identical or similar to those of the auto closing module 7 of the first embodiment described above.

The soft closing module 8 may include a damper 81 and a damper head 85. The structure and function of the soft closing module 8 of this embodiment may be identical or similar to those of the soft closing module 8 of the first embodiment described above.

The closing device 40 may include the housing 460. The housing 460 may include an auto closing housing 467 that supports the auto closing module 7 and a soft closing housing 468 that supports the soft closing housing 468.

The closing device 40 may include a catcher 5. The catcher 5 may be disposed at a lower side of the case 410. The catcher 5 may be identical to the catcher 5 of the first embodiment described above.

The closing device 40 may include a cam 60. The cam 60 may rotate integrally with the catcher 5. The cam 60 may be disposed within the case 410.

The cam 60 may include a first arm 670 and a second arm 680. The first arm 670 and the second arm 680 may be spaced apart in a circumferential direction.

The first arm 670 may protrude toward the auto closing module 7. An end portion of the first arm 670 may be formed to be rounded. The first arm 670 may contact the actuator 75.

The second arm 680 may protrude toward the soft closing module 8. The second arm 680 may have a similar structure to the second arm 68 of the first embodiment described above. When the door 2 is in a closed state, an outer end of the second arm 680 may contact an inclined surface of the head 85, such that a damping force of the soft closing module 8 may not be applied to the cam 6.

The closing device 40 may include a cam support 470. The cam support 470 may be disposed within the case 410.

The closing device 40 of the third embodiment is advantageous in that, because its vertical height is smaller than that of the closing device 4 of the first embodiment, it occupies a smaller height (or vertical space) inside the door 2.

The closing device 4 of the first embodiment is advantageous in that, because its width is smaller than that of the closing device 40 of the third embodiment, the width (or depth) it occupies in the front-rear direction inside the door 2 is small, making it suitable to be installed in a door 2 having a thin thickness.

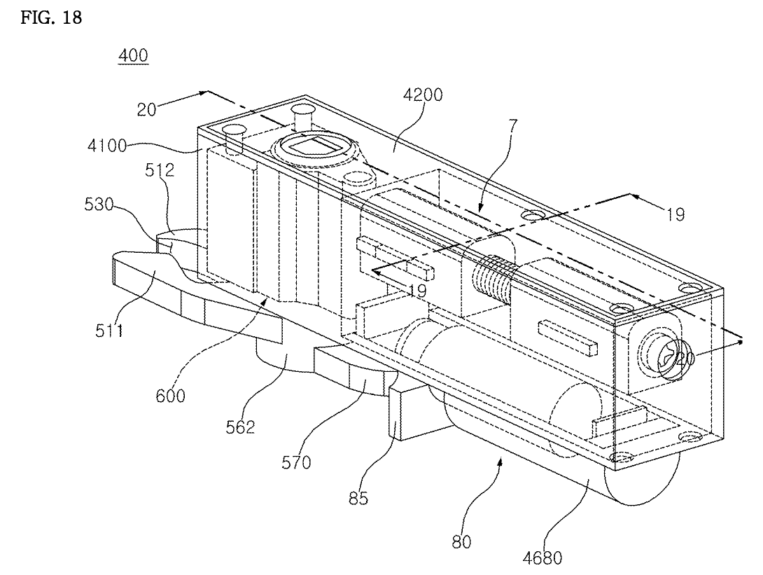

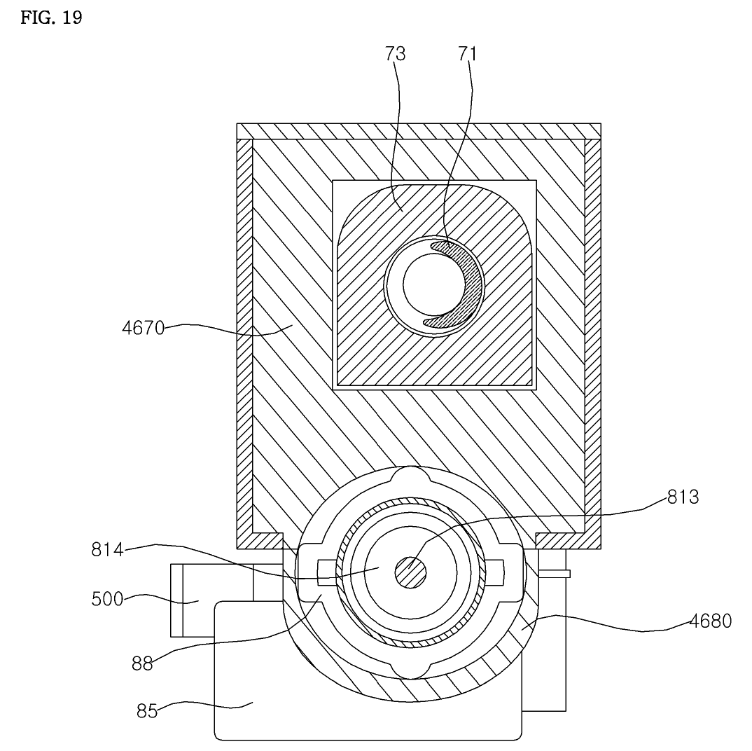

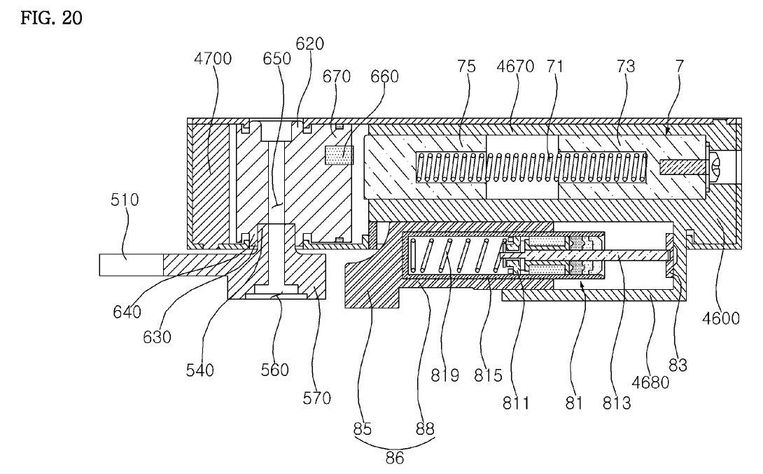

Hereinafter, a closing device 400 of a refrigerator according to a fourth embodiment of the present disclosure will be described with reference to FIGS. 18 - 20.

Referring to FIGS. 18 - 20, compared to the closing device 4 of the first embodiment described above, the closing device 400 of this embodiment differs in that a cam 600 does not include the second arm that interacts with the soft closing module 8, and a catcher 500 includes a catcher cam 570 to interact with the soft closing module 8.

In the following description, features identical or similar to those of the first embodiment described above will be briefly described or detailed descriptions thereof will be omitted.

The closing device 400 may include the catcher 500. The catcher 500 may include a finger 510 and a slit 530. The finger 510 may include first and second fingers 511 and 512. The finger and the slit 530 may be identical to the finger 51 and the slit 53 of the catcher 5 of the first embodiment described above.

The closing device 400 may include a case 4100 and a case cover 4200.

The closing device 400 may include the cam 600 that rotates integrally with the catcher 500. The cam 600 may be disposed within the case 4100.

The cam 600 may include a lower cam shaft 630 and an upper cam shaft 620, and may be rotatably supported by a lower shaft support portion and an upper shaft support portion of the case 4100 and the case cover 4200.

A rotating shaft 540 of the catcher 500 may be inserted into a shaft coupling portion 640 provided at a lower portion of the cam 600, and a fastening member may be inserted into fastening holes 560 and 650 so as to couple the catcher 500 and the cam 600.

The closing device 400 may include an auto closing module 7. The auto closing module 7 may be disposed within the case 4100.

The closing device 400 may include a soft closing module 80. The soft closing module 80 may be disposed at a lower side of the case 4100.

The closing device 400 may include a housing 4600 to accommodate the auto closing module 7. The housing 4600 may include an auto closing housing 4670 in which the auto closing module 7 is accommodated and a soft closing module 4680 in which the soft closing module 80 is accommodated.

The auto closing housing 4670 may be disposed within the case 4100, and the soft closing housing 4680 may be disposed outside the case 4100.

The soft closing module 80 may be disposed below the auto closing module 7.

The cam 600 may include an arm 670 protruding in a radially outward direction. The arm 670 may be provided with a roller 660.

The auto closing module 7 may include a spring 71, a holder 73, and an actuator 75. The auto closing module 7 may include a force adjusting part.

The structure and function of the auto closing module 7 of this embodiment may be identical to those of the auto closing module 7 of the first embodiment described above.

The catcher 500 may include the catcher cam 570 protruding toward the soft closing module 8. The catcher cam 570 may protrude on a side opposite to the finger 510.

The soft closing module 80 may include a damper 81. The damper 81 may have the same structure as the damper 81 of the first embodiment.

The soft closing module 80 may include a coupler 83. The coupler 83 may fix or secure the piston rod 813 to the housing 4600.

The soft closing module 80 may include a damper cover 86. The damper cover 86 may include a body 88 that accommodates the cylinder 815 and a head 85 that protrudes from the body 88. The head 85 may contact the catcher cam 570.

When the auto closing module 7 rotates the cam 600 and the catcher 500, the catcher cam 570 may press the head 85 so that the damper 81 is compressed, and the soft closing module 80 may apply a force to the catcher 500 in a direction opposite to a rotational direction of the catcher 500.

The closing device 400 of this embodiment is advantageous in that, because a height of the case 4100 inserted into the door 2 is small, the height occupied by the closing device 400 inside the door 2 is small.

Certain embodiments or other embodiments of the disclosure described above are not mutually exclusive or distinct from each other. Any or all elements of the embodiments of the disclosure described above may be combined or combined with each other in configuration or function.

For example, a configuration "A" described in one embodiment of the disclosure and the drawings, and a configuration "B" described in another embodiment of the disclosure and the drawings may be combined with each other. Namely, although the combination between the configurations is not directly described, the combination is possible except in the case where it is described that the combination is impossible.

The above detailed description is to be construed in all aspects as illustrative and not restrictive. The scope of the present disclosure should be determined by reasonable interpretation of the appended claims, and all changes coming within the equivalents of the present disclosure are intended to be embraced in the scope of the present disclosure.

What is claimed is:

1. A refrigerator comprising:
a cabinet defining a storage compartment that is open toward a front;
a door rotatably disposed at the front of the cabinet to open and close the storage compartment;
a hinge coupled to the cabinet, the hinge comprising (i) a hinge shaft configured to rotatably support the door and (ii) a reference pin spaced apart from the hinge shaft; and
a closing device configured to provide a force in a direction in which the door is closed,
wherein the closing device comprises:
a catcher including a slit into which the reference pin is inserted, the catcher being configured to be rotatable,
a cam configured to rotate integrally with the catcher, and
an auto closing module configured to apply a force to the cam to rotate the catcher.

2. The refrigerator of claim 1, wherein a rotation center of the catcher is oriented vertically, and
wherein the auto closing module is disposed in a direction intersecting the rotation center of the catcher and includes a spring.

3. The refrigerator of claim 2, wherein the spring is disposed horizontally.

4. The refrigerator of claim 1, wherein the auto closing module comprises:
a spring;
a holder coupled to a first end of the spring; and
an actuator that is coupled to a second end of the spring, configured to slide along a longitudinal direction of the spring, and contacts the cam.

5. The refrigerator of claim 4, wherein the actuator includes an acting surface and a locking surface, and
wherein a rotation center of the cam intersects a line normal to the locking surface, or is located between the line normal to the locking surface and a normal of the acting surface.

6. The refrigerator of claim 5, wherein the cam contacts the locking surface when the reference pin is located outside the slit, and contacts the acting surface when the reference pin is located in the slit.

7. The refrigerator of claim 6, wherein the cam includes an opposing surface that contacts the locking surface when the reference pin is located outside the slit.

8. The refrigerator of claim 4, wherein the cam includes a roller that contacts the actuator.

9. The refrigerator of claim 4, wherein the closing device further comprises a housing to accommodate the auto closing module, and
wherein the auto closing module further comprises a force adjusting part to adjust a position of the holder relative to the housing.

10. The refrigerator of claim 1, wherein the closing device further comprises a cam support located with respect to the cam in a second rotational direction of the cam, and
wherein the second rotational direction is opposite to a first rotational direction in which the cam rotates when the door closes.

11. The refrigerator of claim 10, wherein the cam comprises:
a first arm protruding from a rotation center of the cam toward the auto closing module; and
a second arm protruding from the rotation center of the cam and disposed between the first arm and the cam support.

12. The refrigerator of claim 11, wherein the closing device further comprises a cam stopper located on a second rotational direction side opposite to the first rotational direction with respect to the second arm, the cam stopper contacting the second arm when the door closes.

13. The refrigerator of claim 1, wherein the closing device further comprises a soft closing module configured to apply a force to the cam in a direction opposite to the force applied by the auto closing module.

14. The refrigerator of claim 13, wherein the cam comprises:
a first arm protruding from a rotation center of the cam toward the auto closing module; and
a second arm protruding from the rotation center of the cam toward the soft closing module.

15. The refrigerator of claim 14, wherein the closing device includes a case in which the cam, the auto closing module, and the soft closing module are accommodated, the case being mounted to the door.

16. The refrigerator of claim 15, wherein the auto closing module is disposed above or below the soft closing module.

17. The refrigerator of claim 16, wherein a longitudinal center of the auto closing module and a longitudinal center of the soft closing module are spaced apart in a front-rear direction of the door.

18. The refrigerator of claim 17, wherein the longitudinal center of the auto closing module and the longitudinal center of the soft closing module are spaced apart from the rotation center of the cam toward the front of the door.

19. The refrigerator of claim 14, wherein, when the reference pin is located at an outer end of the slit, the first arm contacts the auto closing module, and the second arm is spaced apart from the soft closing module.

20. The refrigerator of claim 14, wherein the soft closing module comprises:
a damper configured to provide a force applied to the cam; and
a head that is coupled to the damper and contacts the second arm, and
wherein the head includes an inclined surface that is directed toward the rotation center of the cam and contacts the second arm when the door is closed.
